(19) United States
(12) Patent Application Publication
(10) Pub. No.: US 2026/0323479 A1
(43) Pub. Date: Oct. 15, 2026

(54) USER DEFINED TRUSTED ENTITY LIST IN WIRELESS COMMUNICATION NETWORKS

(71) Applicant: T-Mobile USA, Inc., Bellevue, WA (US)

(72) Inventor: Raghavendra Kulkarni, Sammamish, WA (US)

(21) Appl. No.: 19/176,991

(22) Filed: Apr. 11, 2025

(51) Int. Cl. H04W 48/02; H04W 4/14; H04W 48/08

(52) U.S. Cl. CPC H04W 48/02; H04W 4/14; H04W 48/08

(57) ABSTRACT

Techniques and architecture described herein provide a user defined list of trusted entities. For example, the user defined list may comprise a list of approved entities from which incoming communications, e.g., telephone calls and/or text messages, may be accepted, e.g., may be received by the user on one of their electronic devices. More particularly, the user defined list may provide a list of approved or trusted users or entities that may access a wireless communication network from which incoming communications, e.g., telephone calls, short message service (SMS) messages, multimedia service (MMS) messages, rich communication services (RCS) messages, etc., are to be passed on to an electronic device, e.g., a mobile communication device, of the user. The list of trusted entities generally identifies entities and their associated numbers, e.g., telephone numbers, that are allowed to pass incoming communications to the user.

### BACKGROUND

Wireless communication networks provide services to users including, but not limited to, telephone calls and text messaging. The users access the services of the wireless communication network via various types of electronic devices. The most common type of electronic device is a portable electronic device that is generally mobile. Unfortunately, spam telephone calls and text messages are still being received by users within wireless communication networks. The spam telephone calls and spam text messages are being received despite current spam blockers that are in place for spam telephone calls and spam text messages. For example, some users receive a minimum of 10, 15, or even more spam telephone calls and/or spam text messages each day. These communications generally end up in voicemail. The bad actors that originate such spam telephone calls and spam text messages are generally up to no good and may be involved with phishing operations, malware, etc. These spam telephone calls and spam text messages utilize network resources that are meant to be for legitimate telephone calls and/or spam text messages. Thus, in addition to being a nuisance to users of wireless communication networks, such spam telephone calls and spam text messages also lead to inappropriate use of network resources of wireless communication networks.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 schematically illustrates an example block diagram of an architecture for a portion of a wireless communication network that uses a user defined list of trusted entities to approve incoming communications destined for electronic devices within a wireless communication network, according to some implementations.

FIG. 2 is a flow diagram illustrating an example method for using a user defined list of trusted entities to approve incoming communications destined for electronic devices within a wireless communication network, according to some implementations.

FIG. 3 schematically illustrates a component level view of an example mobile communication device configured for use with the techniques and architecture described herein, according to some implementations.

FIG. 4 schematically illustrates a component level view of a server configured for use with the techniques and architecture described herein, according to some implementations.

### DETAILED DESCRIPTION

Described herein are techniques and architecture that provide a user defined list of trusted entities. For example, the user defined list may comprise a list of approved entities from which incoming communications, e.g., telephone calls and/or text messages, may be accepted, e.g., may be received by the user on one of their electronic devices.

More particularly, the user defined list may provide a list of approved or trusted users or entities that may access a wireless communication network from which incoming communications, e.g., telephone calls, short message service (SMS) messages, multimedia service (MMS) messages, rich communication services (RCS) messages, etc., are to be passed on to an electronic device, e.g., a mobile communication device, of the user. The list of trusted entities generally identifies entities and their associated numbers, e.g., telephone numbers, that are allowed to pass incoming communications to the user.

In configurations, the user defined list of approved entities may be maintained at a central database maintained by an operator of the wireless communication network, e.g., the central database may be maintained at the network layer. In communications, the user defined list of approved entities may be maintained on the electronic devices of the user on which the user receives incoming communications.

In configurations, a second list of trusted entities may be maintained and defined by the operator of the wireless communication network. For example, businesses, organizations, people, etc., that have been verified by the operator of the wireless communication network may be included on the second list. The user may opt to allow incoming communications from entities that are on the second list. In configurations, the user may opt out of accepting communications from the second list.

In configurations, the user may periodically receive a list of missed or rejected incoming communications, e.g., communications that were blocked or dropped by the operator of the wireless communication network due to the entity not being on the user defined list or the second list defined by the operator of the wireless communication network. Additionally, the list of missed communications may include communications from the second list defined by the operator of the wireless communication network because the user opted out of accepting incoming communications from entities on the second list. Additionally, the list of missed communications may include communications where the user blocked specific entities or rejected communications from specific entities on the second list defined by the operator of the wireless communication network.

In configurations, the user may review the list of missed communications and may add entities from the list of missed communications to the user's defined list of trusted or approved entities. In configurations, the user may request the list of missed or rejected incoming communications from the operator of the wireless communication network. For example, if the user has been away on vacation for an amount of time, the user may wish to see which incoming communications the user missed. As previously noted, the user may add entities from the list of missed or rejected communications to the user's defined list of trusted entities.

In configurations, the user may have an interface on one or more of their electronic devices that allows the user to request and/or search the list of rejected and/or missed incoming communications. The interface may also be used to update the user defined list of trusted entities.

In configurations, one or more of a call cession control function (CSCF), a proxy-CSCF (PCSCF), a telephony application server (TAS), a SMS, a MMS, or a RCS may enforce (e.g., block or drop incoming communications) the user defined list of trusted entities and/or the second list of trusted entities defined by the operator of the wireless communication network. In configurations, the user's electronic device may enforce (e.g., block or drop incoming communications) the user defined list of trusted entities.

Accordingly, as an example, a method comprises receiving, by a wireless communication network from an electronic device of an originating entity, an incoming communication destined for a receiving entity. The method also comprises determining, by the wireless communication network, whether the originating entity is included on a first list of approved entities, wherein the first list of approved entities is defined by the receiving entity. The method further comprises based at least on the originating entity being included on the first list of approved entities, forwarding, by the wireless communication network, the incoming communication to an electronic device of the receiving entity.

In configurations, the incoming communication comprises a telephone call.

In some configurations, the incoming communication comprises one of a short message service (SMS) message, a multimedia service (MMS) message, or a rich communication services (RCS) message.

In configurations, the method further comprises based at least on the originating entity not being included on the first list of approved entities, dropping, by the wireless communication network, the incoming communication.

In some configurations, the method further comprises based at least on the originating entity not being included on the first list of approved entities, determining, by the wireless communication network, whether the originating entity is included on a second list of approved entities, wherein the second list of approved entities is defined by an operator of the wireless communication network; and based at least on the originating entity being included on the second list of approved entities, forwarding, by the wireless communication network, the incoming communication to the electronic device of the receiving entity.

In some configurations, the method further comprises based at least on the originating entity not being included on the second list of approved entities, dropping, by the wireless communication network, the incoming communication.

In configurations, the method further comprises providing, by the wireless communication network to the receiving entity, a list of missed incoming communications from other entities; and adding, by the receiving entity, one or more of the other entities to the first list of approved entities.

As another example, a system comprises one or more processors; and one or more non-transitory computer-readable media storing computer-executable instructions that, when executed by the one or more processors, cause the one or more processors to perform actions. The actions comprise receiving, by a wireless communication network from an electronic device of an originating entity, an incoming communication destined for a receiving entity. The actions also comprise determining, by the wireless communication network, whether the originating entity is included on a first list of approved entities, wherein the first list of approved entities is defined by the receiving entity. The actions further comprise based at least on the originating entity being included on the first list of approved entities, forwarding, by the wireless communication network, the incoming communication to an electronic device of the receiving entity.

Thus, the techniques and architecture described herein provide a user defined list of trusted entities. For example, the user defined list may comprise a list of approved entities from which incoming communications, e.g., telephone calls and/or text messages, may be accepted, e.g., may be received by the user on one of their electronic devices. More particularly, the user defined list may provide a list of approved or trusted users or entities that may access a wireless communication network from which incoming communications, e.g., telephone calls, short message service (SMS) messages, multimedia service (MMS) messages, rich communication services (RCS) messages, etc., are to be passed on to an electronic device, e.g., a mobile communication device, of the user. The list of trusted entities generally identifies entities and their associated numbers, e.g., telephone numbers, that are allowed to pass incoming communications to the user.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

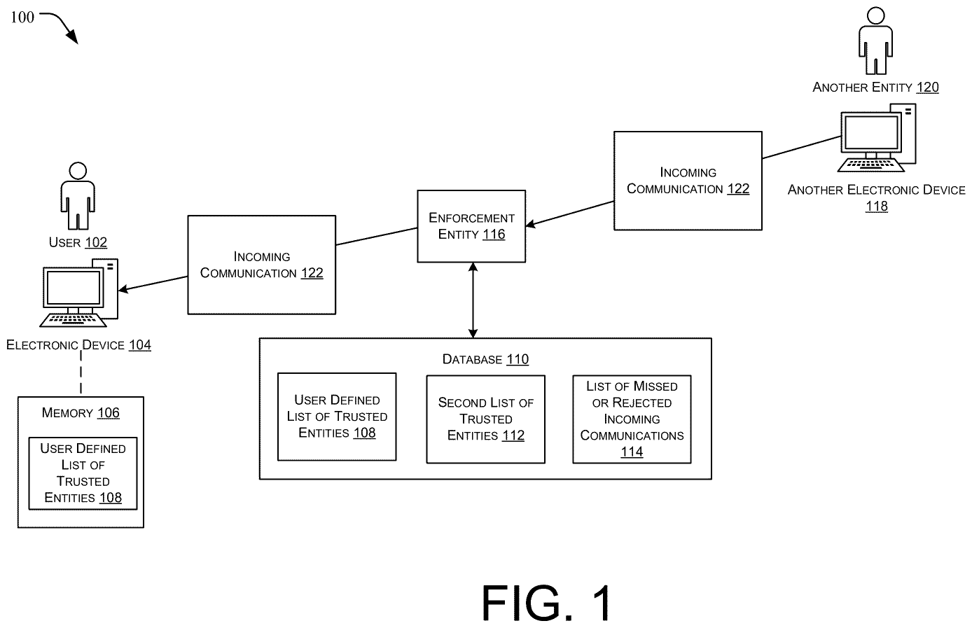

FIG. 1 schematically illustrates an example portion of a wireless communication network 100 (e.g., a mobile network). A user 102 has one or more electronic device(s) 104 (also referred to as mobile communication device(s) 104), e.g., a smart phone, a television, a smart appliance (e.g., an Internet of Things (IoT) device), a laptop, a tablet, a personal computer, etc., that are configured to operate within the wireless communication network 100. In configurations, the one or more electronic device(s) include memory 106 that may store a user defined list of trusted (e.g., approved) entities 108, as will be described further herein. For clarity, the one or more electronic device(s) 104 are referred to herein as electronic device 104.

The example portion of the wireless communication network 100 also includes a database 110 that may store the user defined list of trusted entities 108, a second list of trusted (e.g., approved) entities 112 maintained and defined by the operator of the wireless communication network 100, and a list of missed or rejected incoming communications 114, as will be described further herein. The example portion of the wireless communication network 100 also includes one or more enforcement entities 116, as will be described further herein. In configurations, the one or more enforcement entities 116 may include, for example, one or more of a call cession control function (CSCF), a proxy-CSCF (PCSCF), a telephony application server (TAS), a SMS, a MMS, a RCS or similar entity.

In configurations, the one or more mobile electronic device(s) 104 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the one or more electronic device(s) 104 as being “mobile” (i.e., configured to be carried and moved around), it is to be appreciated that the one or more electronic device(s) 104 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile communication device,” “mobile device,” “computing device,” “portable electronic device,” and “user equipment (UE)” may be used interchangeably herein to describe any communication device capable of performing the techniques described herein.

Furthermore, the one or more electronic device(s) 104 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), 4G Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), 5G, 5G stand-alone (SA), IEEE 802.1x protocols, WiMAX, Wi-Fi, and/or any future IP-based network technology or evolution of an existing IP-based network technology.

In configurations, another electronic device 118 associated with another entity 120 initiates an incoming communication 122 destined for the electronic device 104 of the user 102. The user defined list of trusted entities 108 provides a list of approved or trusted users or entities from which incoming communications, e.g., telephone calls, short message service (SMS) messages, multimedia service (MMS) messages, rich communication services (RCS) messages, etc., are to be passed on to the electronic device 104 of the user 102. The list of trusted entities 108 generally identifies entities and their associated numbers, e.g., telephone numbers, that are allowed to pass incoming communications to the user 102 via the electronic device 104.

In configurations, the user defined list of approved entities 108 may be maintained at the database 110 maintained by the operator of the wireless communication network 100, e.g., the database 110 may be maintained at the network layer. In communications, the user defined list of approved entities 108 may be maintained on the electronic device 104, e.g., in memory 106, of the user 102 on which the user 102 receives incoming communications.

In configurations, the enforcement entity 116 may obtain the user defined list of approved entities 108 from the database 110. If the electronic device 118 and/or the another entity 120 is not included on the user defined list of approved entities 108, the incoming communication 122 may be rejected, e.g., dropped, by the enforcement entity 116. If the electronic device 118 and/or the another entity 120 is included on the user defined list of approved entities 108, the incoming communication 122 may be passed to the electronic device 104 by the enforcement entity 116.

In configurations, the second list of trusted entities 112 may be defined by the operator of the wireless communication network 100 and maintained at the database 110. For example, businesses, organizations, people, etc., that have been verified by the operator of the wireless communication network 100 may be included on the second list of trusted entities 112. The user 102 may opt to allow incoming communications from entities that are on the second list of trusted entities 112. In configurations, the user 102 may opt out of accepting communications from the second list of trusted entities 112. In configurations, entities may be on both lists of approved entities 108, 112.

In configurations, if the user 102 has opted to allow incoming communications from entities that are on the second list of trusted entities 112, the enforcement entity 116 may obtain the second list of trusted entities 112 from the database 110. If the electronic device 118 and/or the another entity 120 is not included on the second list of trusted entities 112, the incoming communication 122 may be rejected, e.g., dropped, by the enforcement entity 116 (unless the electronic device 118 and/or the another entity 120 is included on the user defined list of approved entities 108). If the electronic device 118 and/or the another entity 120 is included on the second list of trusted entities 112, the incoming communication 122 may be passed to the electronic device 104 by the enforcement entity 116.

In configurations, the user 102 may periodically receive the list of missed or rejected incoming communications 114, e.g., communications that were blocked or dropped by the operator of the wireless communication network 100 due to the entity not being on the user defined list of approved entities 108 or the second list of trusted entities 112 defined by the operator of the wireless communication network 100. The list of missed or rejected incoming communications 114 may be maintained at the database 110 for a predetermined amount of time. Additionally, the list of missed or rejected incoming communications 114 may include communications from the second list of trusted entities 112 defined by the operator of the wireless communication network 100 because the user 102 opted out of accepting incoming communications from entities on the second list of trusted entities 112. Additionally, the list of missed incoming communications 114 may include incoming communications where the user 102 specifically blocked specific entities or rejected incoming communications from specific entities on the second list of trusted entities 112 defined by the operator of the wireless communication network 100.

In configurations, the user 102 may review the list of missed incoming communications 114 and may add entities from the list of missed incoming communications 114 to the user's defined list of trusted or approved entities 108. In configurations, the user 102 may request the list of missed or rejected incoming communications 114 from the operator of the wireless communication network 100. For example, if the user 102 has been away on vacation for an amount of time, the user 102 may wish to see which incoming communications the user 102 missed. As previously noted, the user 102 may add entities from the list of missed or rejected communications 114 to the user's defined list of trusted entities 108.

In configurations, the user 102 may have an interface on one or more of their electronic devices 104 that allows the user 102 to request and/or search the list of rejected and/or missed incoming communications 114. The interface may also be used to update the user defined list of trusted entities 108.

As previously noted, in configurations, one or more of a call cession control function (CSCF), a proxy-CSCF (PCSCF), a telephony application server (TAS), a SMS, a MMS, a RCS, or similar entity may act as the enforcement entity 116 and enforce (e.g., block or drop incoming communications) the user defined list of trusted entities 108 and/or the second list of trusted entities 112 defined by the operator of the wireless communication network 100. In configurations, the user's electronic device 104 may enforce (e.g., block or drop incoming communications) the user defined list of trusted entities 108.

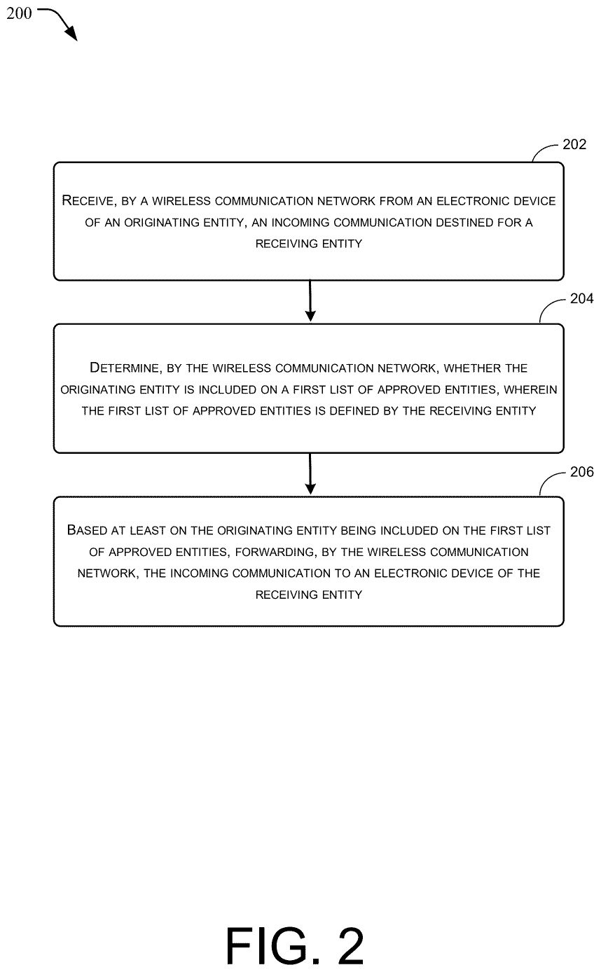

FIG. 2 is a flow diagram illustrating an example method for using a user defined list of trusted entities to approve incoming communications destined for electronic devices, e.g., electronic device 104, within a wireless communication network, e.g., wireless communication network 100. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

At 202, a wireless communication network receives an incoming communication from an electronic device of an originating entity destined for a receiving entity. For example, in configurations, another electronic device 118 associated with another entity 120 initiates an incoming communication 122 destined for the electronic device 104 of the user 102.

At 204, the wireless communication network determines whether the originating entity is included on a first list of approved entities, wherein the first list of approved entities is defined by the receiving entity. For example, in configurations, the user defined list of trusted entities 108 provides a list of approved or trusted users or entities from which incoming communications, e.g., telephone calls, short message service (SMS) messages, multimedia service (MMS) messages, rich communication services (RCS) messages, etc., are to be passed on to the electronic device 104 of the user 102. The list of trusted entities 108 generally identifies entities and their associated numbers, e.g., telephone numbers, that are allowed to pass incoming communications to the user 102 via the electronic device 104. In configurations, the enforcement entity 116 may obtain the user defined list of approved entities 108 from the database 110 and determine if the electronic device 118 and/or the another entity 120 is included on the user defined list of approved entities 108.

At 206, based at least on the originating entity being included on the first list of approved entities, the wireless communication network forwards the incoming communication to an electronic device of the receiving entity. For example, if the electronic device 118 and/or the another entity 120 is not included on the user defined list of approved entities 108, the incoming communication 122 may be rejected, e.g., dropped, by the enforcement entity 116. If the electronic device 118 and/or the another entity 120 is included on the user defined list of approved entities 108, the incoming communication 122 may be passed to the electronic device 104 by the enforcement entity 116.

Thus, the techniques and architecture described herein provide a user defined list of trusted entities. For example, the user defined list may comprise a list of approved entities from which incoming communications, e.g., telephone calls and/or text messages, may be accepted, e.g., may be received by the user on one of their electronic devices. More particularly, the user defined list may provide a list of approved or trusted users or entities that may access a wireless communication network from which incoming communications, e.g., telephone calls, short message service (SMS) messages, multimedia service (MMS) messages, rich communication services (RCS) messages, etc., are to be passed on to an electronic device, e.g., a mobile communication device, of the user. The list of trusted entities generally identifies entities and their associated numbers, e.g., telephone numbers, that are allowed to pass incoming communications to the user.

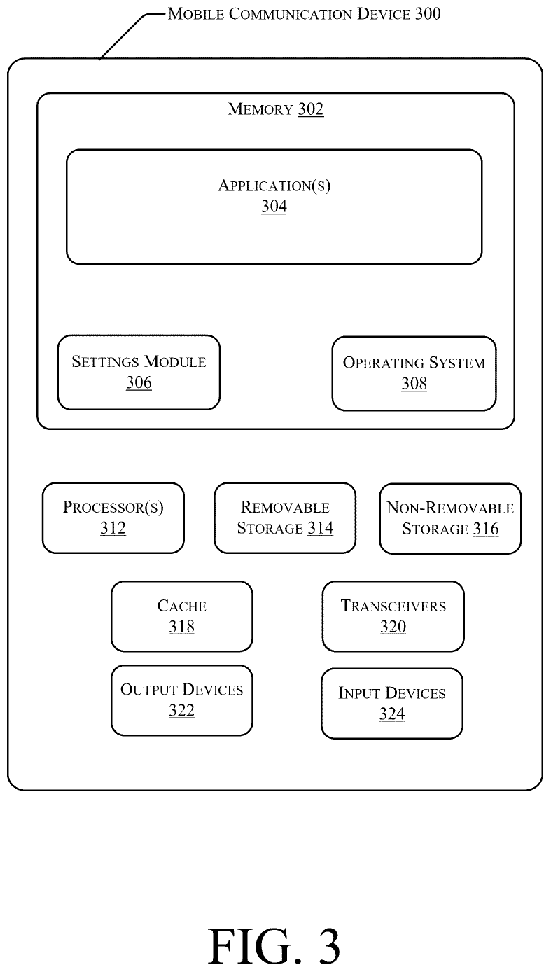

FIG. 3 schematically illustrates a component level view of a mobile communication device 300, such as electronic device(s) 104, configured to function within wireless communication networks. As illustrated, the mobile communication device 300 comprises a system memory 302, e.g., computer-readable media, storing application(s) 304. Alternatively, the functions and UIs may be implemented, wholly or in part, via firmware (not illustrated). The mobile communication device 300 also comprises a settings module 306, and an operating system 308. Also, the mobile communication device 300 includes processor(s) 312, a removable storage 314, a non-removable storage 316, cache 318, transceivers 320, output device(s) 322, and input device(s) 324. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The mobile communication device 300 may also include additional data storage devices (removable and/or non-removable) such as, for example, magnetic disks, optical disks, or tape. Such additional data storage may include removable storage 314 and non-removable storage 316. Additionally, the mobile communication device 300 includes cache 318.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the mobile communication device 300. Any such non-transitory computer-readable media may be part of the mobile communication device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna (not shown). Also, or alternatively, the transceivers 320 may include wireless modem(s) to facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the mobile communication device 300 to define how the user wishes certain calls from third parties to be handled by the wireless communication network, as previously described herein.

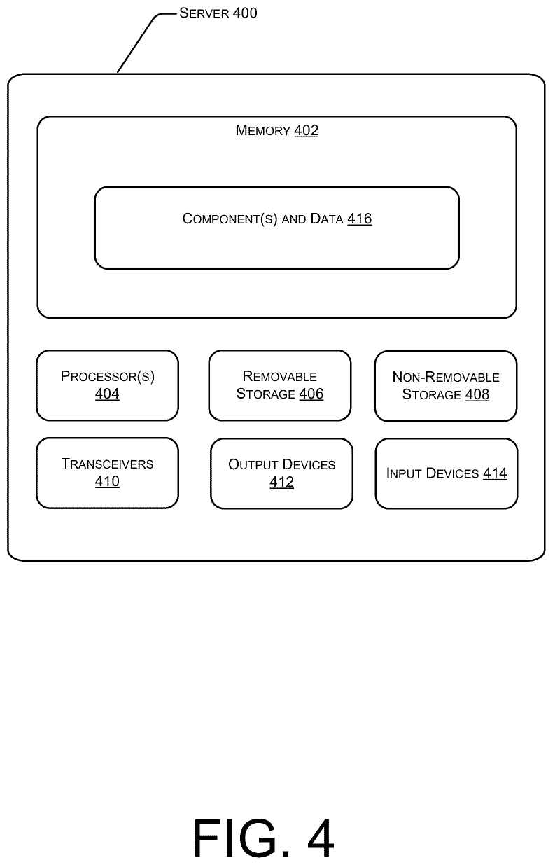

FIG. 4 schematically illustrates a component level view of a server 400 configured for use within a wireless communication network, e.g., wireless communication network 100, in order to provide various services within the wireless communication network, according to the techniques described herein. For example, the server 400 may serve as the enforcement entity 116, e.g., one or more servers 400 may be configured to serve as the enforcement entity 116. As another example, the server 400 may serve as the database 110, e.g., one or more servers 400 may be configured to serve as the database 110.

As illustrated, the server 400 comprises a system memory 402 that may store one or more components and/or applications and data 416 for interacting with mobile communication devices, e.g., mobile communication device 104, as described herein. Also, the server 400 may include processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.), or some combination of the two. In some implementations, the processor(s) 404 is a Central Processing Unit (CPU), a Graphics Processing Unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable storage 408 may include module(s) and data 416 (illustrated in the memory 402). The module(s) and data 416 may include instructions executable by, for example, the processor(s) 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also, or instead, the transceivers 410 may include wireless modem(s) to facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1 and 2. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, by a wireless communication network from an electronic device of an originating entity, an incoming communication destined for a receiving entity;
determining, by the wireless communication network, whether the originating entity is included on a first list of approved entities, wherein the first list of approved entities is defined by the receiving entity; and
based at least on the originating entity being included on the first list of approved entities, forwarding, by the wireless communication network, the incoming communication to an electronic device of the receiving entity.

2. The method of claim 1, wherein the incoming communication comprises a telephone call.

3. The method of claim 1, wherein the incoming communication comprises one of a short message service (SMS) message, a multimedia service (MMS) message, or a rich communication services (RCS) message.

4. The method of claim 1, further comprising:
based at least on the originating entity not being included on the first list of approved entities, dropping, by the wireless communication network, the incoming communication.

5. The method of claim 1, further comprising:
based at least on the originating entity not being included on the first list of approved entities, determining, by the wireless communication network, whether the originating entity is included on a second list of approved entities, wherein the second list of approved entities is defined by an operator of the wireless communication network; and
based at least on the originating entity being included on the second list of approved entities, forwarding, by the wireless communication network, the incoming communication to the electronic device of the receiving entity.

6. The method of claim 5, further comprising:
based at least on the originating entity not being included on the second list of approved entities, dropping, by the wireless communication network, the incoming communication.

7. The method of claim 1, further comprising:
providing, by the wireless communication network to the receiving entity, a list of missed incoming communications from other entities; and
adding, by the receiving entity, one or more of the other entities to the first list of approved entities.

8. A system comprising:
one or more processors; and
one or more non-transitory computer-readable media storing computer-executable instructions that, when executed by the one or more processors, cause the one or more processors to perform actions comprising:
receiving, by a wireless communication network from an electronic device of an originating entity, an incoming communication destined for a receiving entity;
determining, by the wireless communication network, whether the originating entity is included on a first list of approved entities, wherein the first list of approved entities is defined by the receiving entity; and
based at least on the originating entity being included on the first list of approved entities, forwarding, by the wireless communication network, the incoming communication to an electronic device of the receiving entity.

9. The system of claim 8, wherein the incoming communication comprises a telephone call.

10. The system of claim 8, wherein the incoming communication comprises one of a short message service (SMS) message, a multimedia service (MMS) message, or a rich communication services (RCS) message.

11. The system of claim 8, wherein the actions further comprise:
based at least on the originating entity not being included on the first list of approved entities, dropping, by the wireless communication network, the incoming communication.

12. The system of claim 8, wherein the actions further comprise:
based at least on the originating entity not being included on the first list of approved entities, determining, by the wireless communication network, whether the originating entity is included on a second list of approved entities, wherein the second list of approved entities is defined by an operator of the wireless communication network; and
based at least on the originating entity being included on the second list of approved entities, forwarding, by the wireless communication network, the incoming communication to the electronic device of the receiving entity.

13. The system of claim 12, wherein the actions further comprise:
based at least on the originating entity not being included on the second list of approved entities, dropping, by the wireless communication network, the incoming communication.

14. The system of claim 8, wherein the actions further comprise:
providing, by the wireless communication network to the receiving entity, a list of missed incoming communications from other entities; and
adding, by the receiving entity, one or more of the other entities to the first list of approved entities.

15. One or more non-transitory computer-readable media storing computer-executable instructions that, when executed by one or more processors, cause the one or more processors to perform actions comprising:
receiving, by a wireless communication network from an electronic device of an originating entity, an incoming communication destined for a receiving entity;
determining, by the wireless communication network, whether the originating entity is included on a first list of approved entities, wherein the first list of approved entities is defined by the receiving entity; and
based at least on the originating entity being included on the first list of approved entities, forwarding, by the wireless communication network, the incoming communication to an electronic device of the receiving entity.

16. The one or more non-transitory computer-readable media of claim 15, wherein the incoming communication comprises a telephone call.

17. The one or more non-transitory computer-readable media of claim 15, wherein the incoming communication comprises one of a short message service (SMS) message, a multimedia service (MMS) message, or a rich communication services (RCS) message.

18. The one or more non-transitory computer-readable media of claim 15, wherein the actions further comprise:
based at least on the originating entity not being included on the first list of approved entities, dropping, by the wireless communication network, the incoming communication.

19. The one or more non-transitory computer-readable media of claim 15, wherein the actions further comprise:
based at least on the originating entity not being included on the first list of approved entities, determining, by the wireless communication network, whether the originating entity is included on a second list of approved entities, wherein the second list of approved entities is defined by an operator of the wireless communication network; and
based at least on the originating entity being included on the second list of approved entities, forwarding, by the wireless communication network, the incoming communication to the electronic device of the receiving entity.

20. The one or more non-transitory computer-readable media of claim 15, wherein the actions further comprise:
providing, by the wireless communication network to the receiving entity, a list of missed incoming communications from other entities; and
adding, by the receiving entity, one or more of the other entities to the first list of approved entities.
